(19) United States
(12) Patent Application Publication
(10) Pub. No.: US 2025/0162529 A1
(43) Pub. Date: May 22, 2025

(54) EMERGENCY SAFETY DEVICE FOR VEHICLES

(71) Applicant: SUITE OF SAFETY, LLC, Boerne, TX (US)

(72) Inventors: Tanya Rayfield, Amarillo, TX (US); John Rayfield, Boerne, TX (US)

(73) Assignee: SUITE OF SAFETY, LLC, Boerne, TX (US)

(21) Appl. No.: 18/950,122

(22) Filed: Nov. 17, 2024

Related U.S. Application Data
(60) Provisional application No. 63/600,478, filed on Nov. 17, 2023.

(51) Int. Cl. B60R 21/01; B60R 21/00

(52) U.S. Cl. CPC B60R 21/01; B60R 2021/0016

(57) ABSTRACT

A vehicle safety device designed for emergency situations where a vehicle becomes submerged in water includes a water tight housing with water sensors, an inlet valve operatively coupled to one of the sensors, and liquid flow channel. The device may be configured for being installed in the engine compartment of the vehicle. Upon detection of submersion, the device activates an interior lighting system, comprising LED light strips, to enhance visibility and reduce disorientation. Powered by a power source, such as solar panels or the vehicle's battery, the device aims to increase occupants' chances of survival and escape during underwater emergencies.

### CROSS-REFERENCE TO RELATED APPLICATIONS

This Application claims priority to U.S. Provisional Patent Application No. 63/600,478 filed on Nov. 17, 2023, entitled “Emergency Safety Device for Vehicles.” the contents of which are incorporated herein by reference.

### BACKGROUND

### Field of the Art

The present invention pertains to the field of emergency safety devices for vehicles, particularly to an emergency safety device designed to improve survival chances during vehicle submersion incidents.

### Discussion of the State of the Art

Vehicle submersion incidents are an unfortunate but prevalent reality, causing hundreds of fatalities annually. These incidents occur when vehicles, due to accidents or other unforeseen circumstances, end up underwater, effectively trapping the occupants inside. The primary challenges faced by individuals in these situations include disorientation, panic, and a critical lack of visibility, particularly in murky or dark water environments. These factors combined significantly hinder the occupants' ability to escape, leading to a high likelihood of drowning.

The situation is further exacerbated by the fact that the pressure differential between the interior and exterior of the vehicle makes it almost impossible to open the doors until the vehicle is almost completely filled with water. This delay can prove fatal, especially if the occupants are not prepared or do not have the necessary tools to break the vehicle's windows and escape.

In an attempt to mitigate these risks, various safety tools have been developed and made available in the market. One such tool is the window-breaking tool, designed to shatter automotive glass and provide a means of escape. However, these tools have several inherent flaws that limit their effectiveness in a real-world submersion scenario.

Firstly, these tools need to be within easy reach during an emergency, which may not always be the case. In the panic and disorientation that often accompanies such situations, locating and retrieving these tools can be extremely challenging. Secondly, the successful use of these tools requires a certain degree of physical strength and precision, both of which can be compromised under high-stress conditions. Lastly, even if the tool is successfully used to break a window, the sudden inrush of water can be disorienting and dangerous, further lowering the chances of a successful escape.

Furthermore, these tools do nothing to address the issues of visibility and orientation within the submerged vehicle, which are critical factors in successful escape scenarios. In summary, while the existing solutions provide some means of escape, their effectiveness is significantly limited by various factors, rendering them sub-optimal in effectively addressing the problem at hand.

The existing solutions, therefore, do not adequately address the urgent need for a means of quick orientation and action in the extreme and disorienting conditions of a submerged vehicle.

### SUMMARY

The emergency safety device in accordance with the present invention overcomes the challenges of prior solutions by presenting a comprehensive, integrated emergency safety mechanism for submerged vehicles. Traditional emergency tools are usually manually operated and rely on the presence of mind and physical strength of the occupants, which can be severely compromised in such life-threatening situations. This emergency safety device, on the other hand, automatically detects water ingress and initiates a series of actions designed to increase the chances of survival without requiring manual intervention.

The benefits of this emergency safety device are manifold. Firstly, the automatic detection of water ingress and subsequent activation of safety systems makes the emergency safety device highly reliable and effective, even in scenarios where the occupants may be disoriented or physically incapacitated. Secondly, the use of LED lights to illuminate the interior of the vehicle reduces panic and disorientation, thereby facilitating quicker and more effective escape efforts. The potential integration of these lights within the cabin further enhances visibility, ensuring that all occupants can clearly see their surroundings and the best path to safety.

Additionally, the automatic release of seat belts simplifies the escape process by eliminating the need to manually unbuckle, which can be difficult under water pressure. Finally, the versatile power options for the emergency safety device, including solar power and connection to the vehicle's battery, ensure that the emergency safety device remains operational even in prolonged submersion scenarios, providing continuous support to the occupants as they attempt to escape. Overall, the emergency safety device in accordance with the present invention represents a significant advancement in vehicle safety technology, offering a more effective and comprehensive solution to the challenge of escaping from a submerged vehicle.

In accordance with the present invention, the emergency safety device is designed to enhance the chances of successful escape from a submerged vehicle. This device is intended to be installed within the engine compartment of a vehicle. The safety device comprises a watertight housing equipped with water sensors and an inlet valve. These components work together to detect the rising water level and activate emergency systems within the passenger cabin of the vehicle.

Upon activation, the safety device is configured to illuminate the interior of the vehicle using LED lights. This illumination serves to reduce panic and disorientation by improving visibility, thereby aiding the occupants in orienting themselves and taking appropriate action. The LED lights are designed to be integrated within the cabin of the vehicle, potentially outlining the roof to ensure complete illumination of the cabin space.

In one example, the present invention is a vehicle safety device having a housing that is water tight so that components inside the housing are protected from water ingress. The housing includes a top surface, a bottom surface having a bottom sensor opening, and side surfaces extending between the top surface and the bottom surface. The housing may be configured for being coupled to a vehicle. For example, the housing may be configured for being coupled to an engine compartment of the vehicle.

The safety device further includes an inlet water sensor operably coupled to the bottom sensor opening in the bottom surface of the housing. The inlet water sensor is configured to detect whether liquid is present near the bottom surface of the housing. Still further, the safety device includes an inlet valve operably coupled to the inlet water sensor. The inlet valve is configured to open when the inlet water sensor detects that liquid is present. The inlet valve may additionally be configured to minimize resistance to incoming water, and may feature a valve gate design that promotes quick and unobstructed water flow. The inlet valve may have a solenoid actuator that is activated by a signal from the inlet water sensor, causing a movable valve gate to open quickly to allow rapid water entry into the liquid flow channel.

The safety device further includes a liquid flow channel extending through the housing and having an inlet end coupled to the inlet valve, and an outlet end at the top surface of the housing. Still further, the safety device includes an upper water sensor operably coupled to an upper sensor opening adjacent to the outlet end of the liquid flow channel. The upper water sensor is further configured to be operably coupled to emergency systems inside a passenger cabin of the vehicle and to activate the emergency systems when liquid is detected near the top surface of the housing. The inlet water sensor and the upper water sensor may be housed inside the housing.

The safety device may include an impeller operably coupled to the inlet water sensor. The impeller may be configured to activate when the inlet water sensor detects that liquid is present to thereby draw liquid into the liquid flow channel.

The safety device may include a power source. The power source may include a solar panel, a rechargeable battery, a fixed battery, and/or a vehicle battery. The inlet water sensor and the upper water sensor may be operably coupled to the power source. The power source may be housed inside the housing.

The safety device may further include a control system housed inside the housing. The control system may be operably coupled to the inlet water sensor, upper water sensor, and the inlet valve. The control system may include a microcontroller programmed to process inputs from the inlet water sensor and the upper water sensor, and to control outputs to the inlet valve and emergency systems within the passenger cabin.

In another example, the present invention is a method of activating emergency systems in a submerged vehicle. The method includes detecting the presence of water at a lower portion of the submerged vehicle using an inlet water sensor, sending a signal from the inlet water sensor to open an inlet valve, allowing water to enter a liquid flow channel through the opened inlet valve, detecting when the water reaches a predetermined threshold within the liquid flow channel using an upper water sensor, and triggering emergency systems within the passenger cabin based on water detection by the upper water sensor. The method may also include, after detecting the presence of water, sending a signal from the inlet water sensor to activate an impeller that is configured to draw water into the liquid flow channel.

In summary, the emergency safety device improves safety in submerged vehicle scenarios by addressing the critical issues of visibility, orientation, and accessibility of escape tools. The design and functionality of the safety device represent a significant advancement over existing solutions, offering a more effective means of aiding occupants in escaping from submerged vehicles.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a block diagram of an emergency safety device for a vehicle, in accordance with an embodiment of the present invention.

FIG. 2 depicts a bottom surface of an emergency safety device for a vehicle, in accordance with an embodiment of the present invention.

FIG. 3 depicts a top surface of an emergency safety device for a vehicle, in accordance with an embodiment of the present invention.

FIG. 4 is a flow chart illustrating a method for activating emergency systems within a passenger cabin of a submerged vehicle, in accordance with an embodiment of the present invention.

### DETAILED DESCRIPTION

The present invention is an emergency safety device for vehicles that is configured to be installed within an engine compartment of the vehicle and to activate emergency systems within the passenger cabin of the vehicle when the safety device determines that the vehicle is submerged.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Apparatus

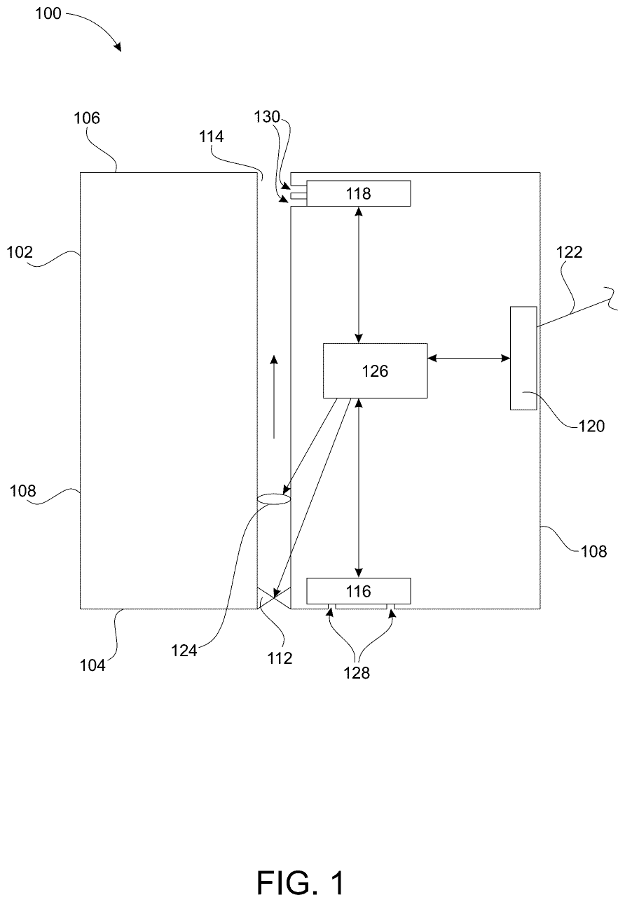

As illustrated in FIG. 1, the emergency safety device 100 includes a housing 102, an inlet valve 112, a liquid flow channel 114, an inlet water sensor 116, an upper water sensor 118, a power source 120 and wiring 122 that is coupled to emergency systems inside the passenger cabin of the vehicle. The safety device 100 may further include a control system 126 disposed within the housing 102 and operatively coupled to the power source 120, sensors 116, 118, inlet valve 112, and (optionally) an impeller 124. The sensors 116, 118 are designed to detect the rising water level within the engine compartment of the vehicle. When the water sensors 116, 118 detect a certain threshold of water level, indicating a potential submersion scenario, they trigger the activation of the emergency systems within the passenger cabin of the vehicle. The inlet valve 112 aids in the detection process by allowing water to enter the housing in a controlled manner, thereby ensuring accurate water level measurement

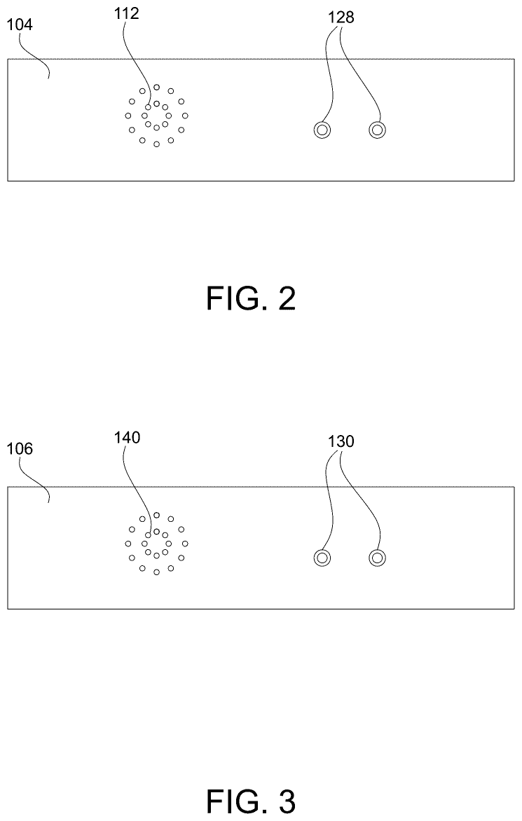

The housing 102 is watertight in order to protect internal components from water ingress and maintain the functionality of the device 100 in a submerged vehicle. The sensors 116, 118, control system 126, and power source 120 are contained in the internal cavity of the housing 102. The housing 102 includes a top surface 106, a bottom surface 104, and side surfaces 108 extending between the top surface 106 and the bottom surface 104. When the emergency safety device 100 is installed in a vehicle, the bottom surface 104 faces towards the ground and the bottom of the vehicle and the top surface 106 faces towards the top of the vehicle. The bottom surface 104 and top surface 106 are further illustrated in FIGS. 2 and 3, respectively.

The bottom surface 104 of the housing 102 includes bottom sensor openings 128 that lead to the inlet water sensor 116. The inlet water sensor 116 is configured to determine whether there is liquid present near the bottom surface 104 of the housing 102. The emergency safety device 100 may be placed within a compartment of a vehicle that is not watertight. In one example, the apparatus 100 may be placed in an engine compartment of a vehicle. In another example, the apparatus 100 may be placed within the heaviest portion of a vehicle such that the apparatus 100 may receive water as early as possible if the vehicle is submerged in water or sinking.

The inlet valve 112 permits water entry into the liquid flow channel 114 when the vehicle becomes submerged. The design of the inlet valve 112 is optimized to offer minimal resistance to water flow, facilitating rapid filling of the liquid flow channel 114 that extends through the housing 102.

In one embodiment, the inlet valve 112 is operably coupled to the inlet water sensor 116 through the control system 126. The inlet water sensor 116 is configured to activate the inlet valve 112 when liquid is present, allowing the valve 112 to open when a certain amount of water is detected. In one embodiment, as the vehicle becomes submerged, water accumulates around the engine compartment. When the water reaches a predefined level, the inlet water sensor 116 activates, sending a signal to the inlet valve 112. This signal triggers the valve 112 to open, allowing water to flow into the liquid flow channel 114. As water reaches the top of the liquid flow channel 114, the upper water sensor 118 is activated, which subsequently triggers the emergency systems within the passenger cabin of the vehicle. For example, the upper water sensor 118 may activate LED lights and other safety mechanisms like an automatic seat belt release.

The inlet water sensor 116, in one embodiment, is strategically positioned at the bottom surface 104 of the housing 102. The inlet water sensor 116 detects moisture and helps open the inlet valve 112. In operation, as the vehicle becomes submerged and water begins to accumulate, the inlet water sensor 116 detects the rising water levels. In one example, the inlet water sensor 116 is a mechanical sensor that activates as float components rise. In another example, the inlet water sensor 116 is an electronic sensor that responds to the environmental changes caused by water. Upon activation, the sensor 116 sends a signal to the control system 126 within the housing 102, which triggers the opening of the inlet valve 112, leading to the activation of various safety features designed to aid in an emergency when the water reaches a predetermined level.

Constructed from durable, water-resistant materials, the inlet sensor 116 is designed to withstand various environmental conditions, ensuring reliable operation. The inlet sensor 116 may be mechanical or electronic. Mechanical sensors typically employ a float system that rises with the water level, activating the sensor. Electronic sensors, on the other hand, detect water presence through changes in electrical properties such as conductivity or capacitance.

Alternative sensor technologies offer varied approaches to detecting water presence. Capacitive sensors measure changes in capacitance caused by submersion, while conductive sensors detect water through the completion of an electrical circuit. Optical sensors employ a light beam that, when interrupted by water, triggers the sensor. Pressure transducers are sensitive to changes in pressure associated with water depth, and ultrasonic sensors use changes in ultrasonic wave reflection patterns to detect submersion.

Each alternative presents unique advantages in sensitivity, response time, cost, and adaptability to environmental conditions, allowing for customization based on specific requirements of the safety system. The choice of sensor technology influences the effectiveness and reliability of the submerged vehicle safety system, ensuring timely activation and operation of the safety mechanisms in emergency scenarios.

In one embodiment, the inlet valve 112 comprises a valve body, a movable valve gate or flap, and a spring mechanism. The valve gate is designed to remain sealed under standard operating conditions but opens when activated by input from the inlet sensor, such as when the input sensor 116 detects the presence of water. Material selection for the valve 112 and its components ensures durability, including but not limited to corrosion-resistant materials like stainless steel, reinforced plastics, or specialized alloys.

In one embodiment, the trigger mechanism of the valve 112 is primarily driven by the inlet water sensor 116, which can be either mechanical, such as a float-type sensor, or electronic, detecting water presence through changes in electrical properties. The inlet water sensor 116 activates the inlet valve 112. Mechanical sensors may lift the valve gate directly, while electronic sensors often use a solenoid or motorized actuator. The solenoid or motorized actuator may be activated by a signal from the inlet water sensor 116, causing a movable valve gate to open quickly to allow rapid water entry into the liquid flow channel 114. This design ensures that the valve 112 opens promptly upon detecting water, allowing for the activation of the safety system.

Furthermore, the valve 112 is engineered for improved water flow dynamics. The design of the valve gate and body minimizes resistance to incoming water, allowing quick and unobstructed water flow. This feature enables water to rapidly fill the liquid flow channel 114 to thereby trigger the subsequent safety systems, such as interior lighting and automatic seat belt release.

Several alternative embodiments of the inlet valve can be used without departing from the scope of the invention. One such variation includes an impeller-assisted inlet valve, which integrates an impeller 124 to speed up the water intake. This design is particularly beneficial in situations where a rapid rise in water level is expected, ensuring a quicker activation of the device's safety features.

Another alternative is the gravity-operated inlet valve, which uses the weight of the incoming water to open. This simpler design may be more reliable due to fewer moving parts, thus reducing the potential for mechanical failure. Additionally, an electronically controlled inlet valve, utilizing electronic mechanisms to open based on sensor inputs, can provide precise control over the valve's operation, leading to a more responsive system.

A manual override feature in the inlet valve 112 may be used without departing from the scope of the invention. This feature allows occupants to open the valve 112 manually, providing an extra layer of control, especially useful if the automatic sensors fail to trigger the valve 112. Lastly, a pressure-sensitive inlet valve operates by responding to the pressure exerted by the water against it. This design functions independently of electronic sensors, providing a fail-safe mechanism that is purely mechanical and ensures operation even in the absence of electrical power.

The water channel 114 can serve as a conduit, allowing water that enters through the inlet valve 112 to reach the upper water sensor 118 within the apparatus 100, thereby triggering the necessary emergency response. In its basic design, the water channel 114 is a straightforward pathway within the housing 102. The channel 114 is crafted to ensure a smooth, unobstructed flow of water. The dimensions and structure of the channel 114 are optimized to handle a quick influx of water, enabling a rapid response in emergent situations. Upon submersion, water enters the liquid flow channel 114 through the inlet valve 112 and begins filling the channel 114. As the water level rises within the channel 114, the water eventually reaches the upper sensor 118 strategically positioned near the top surface 106 of the housing 102.

Alternative designs of the water channel 114 can be used without departing from the scope of the invention, including, but not limited to, water channels of various lengths, shapes, and diameters.

In one embodiment, the water channel 114 can be integrated with an impeller 124 placed within or near the channel 114. This impeller 124 actively draws water through the channel 114, ensuring that the upper sensors 118 are reached more quickly and/or reliably, especially in situations where the water level rises slowly. This design is particularly useful in ensuring a swift activation of the safety features.

In one embodiment, the device includes a segmented channel design. In this configuration, the channel is divided into multiple sections, each equipped with its own sensor. This segmentation allows for more precise monitoring of water levels and can enable a staged activation of safety features, offering a more tailored response to varying emergency scenarios.

A gravity-assisted channel design utilizes the natural force of gravity to expedite water flow towards the sensors. By angling the channel downwards, this design ensures that water flows naturally and swiftly towards the sensor area, reducing the reliance on mechanical aids for water movement.

For situations where the amount of water can vary significantly, an expandable channel offers an adaptable solution. This design incorporates materials or mechanisms that allow the channel to expand or change shape, accommodating different volumes of water and ensuring consistent performance under various submersion conditions.

Additionally, integrating a filtration system within the channel 114 can prevent potential clogging or obstruction by debris. This filtration system ensures that the water pathway remains clear, maintaining an uninterrupted flow towards the sensors.

The upper sensor 118 may be placed within the housing 102 near the top surface 106 and/or near and/or along the water channel 114 to detect the presence and level of water. When the upper sensor 118 detects the presence of water, safety mechanisms in the passenger cabin of the vehicle are activated.

The upper water sensor 118 is in communication with the top of the liquid flow channel 114 in order to determine whether the liquid has reached the top of the liquid flow channel 114. For example, upper sensor openings 130 extend between the upper water sensor 118 and the upper portion of the liquid flow channel 114. Alternatively, the openings 130 may extend between the upper water sensor 118 and the top surface 106 of the housing 102, as shown in FIG. 3. FIG. 3 further depicts a valve 140 at the top of the liquid flow channel 114. The top of the liquid flow channel 114 may be open, as shown in FIG. 1, or may include a valve 140, as shown in FIG. 3. In one example, the inlet valve 112 and the outlet valve 140 may be closed so that water flow into the channel 114 may be turned off after the emergency systems inside the passenger cabin have been activated.

Located strategically within the housing 102, in one embodiment, near the top 106, the upper sensor 118 is engineered to be highly sensitive to environmental changes, especially to water. The primary function of the upper sensor 118 is to detect when the water level inside the liquid flow channel 114 reaches a critical height, indicating significant submersion of the vehicle. Upon detecting this condition, the upper sensor 118 sends a signal to the control system 126 of the apparatus 100. The control system 126 then triggers emergency responses within the passenger cabin, such as lighting up LED lights for visibility and potentially activating other safety features like the automatic release of seatbelts.

Various types of sensors can be employed for the upper water sensor 118, each with its unique method of detection. Common choices include float sensors, which physically rise with the increasing water level, and electronic sensors, which are adept at detecting changes in pressure or electrical conductivity as water enters the compartment. The selection of sensor type hinges on design requirements and desired response characteristics.

Alternative sensor options extend the flexibility and adaptability of the system. Pressure sensors, for instance, operate based on the water pressure and are valued for their quick detection capabilities. Capacitive sensors, on the other hand, detect the presence of water through changes in electrical capacitance, offering high sensitivity and precision. Optical sensors, though less common, use light-based technology to detect changes in light patterns caused by water, providing an innovative approach to detection.

Conductive sensors, which monitor changes in electrical conductivity to signify the presence of water, and ultrasonic sensors, that measure the distance to the water surface using sound waves, present other viable alternatives. Each sensor type brings its advantages in terms of response time, accuracy, cost-efficiency, and durability, making the selection a matter of aligning with specific requirements and constraints of the safety system.

The emergency safety device 100 for submerged vehicles may be powered by a power source 120. The power source 120 is operatively coupled to a wiring system 122 that is coupled to safety systems within the passenger cabin of the vehicle, such as LED lights and other emergency systems like automatic seatbelt releases.

In one embodiment, the power source 120 provides electrical energy to activate these systems upon submersion. A variety of power sources may be used, including, but not limited to solar panels coupled to a battery, which may be discreetly placed in areas like the vehicle's grille. These panels harness solar energy, utilizing it directly or storing it in rechargeable batteries, ensuring a sustainable and reliable energy supply. Alternatively, the vehicle's existing electrical system, primarily the car battery, can be integrated, ensuring that the emergency systems are powered as long as the car battery maintains charge. Another option is a dedicated battery system within the device, which can be either rechargeable or replaceable, providing flexibility in design and ensuring reliability under various conditions.

The wiring system 122 connects the power source 120 to the emergency systems within the passenger cabin. The wiring system 122 is designed for efficient power distribution from the power source 120 to the LED lights and other components, minimizing energy loss and ensuring optimal performance. Considering the potential exposure to water, the system is waterproof and insulated to prevent any electrical hazards. The materials used are selected for their durability and resistance to water, ensuring safety. Furthermore, this system is integrated with the vehicle's existing electrical layout in a manner that does not impede normal vehicle operations but is readily activated in emergencies. The system's modularity and adaptability allow for easy integration with various vehicle models and the accommodation of different emergency systems.

In addition to these configurations, alternative power and wiring setups can be considered. Emerging technologies like wireless (inductive) power transfer could reduce reliance on traditional wiring, particularly for connections between the vehicle's main power source and the emergency device 100. Energy harvesting technologies that capture kinetic or thermal energy from the vehicle could offer an auxiliary power source, adding redundancy to the system.

In other words, the power source 120 and wiring system 122 are designed for swift activation and consistent functioning of emergency systems in submerged vehicles. Their design incorporates considerations for durability, safety, and compatibility with a range of vehicle architectures. The flexibility in power source options and wiring configurations enhances the system's adaptability, allowing it to be tailored to diverse vehicle types and manufacturer requirements.

In one example, the control system 126 includes a microcontroller programmed to process inputs from the inlet water sensor 116 and the upper water sensor 118, and to control outputs to the inlet valve 112 and emergency systems within the passenger cabin.

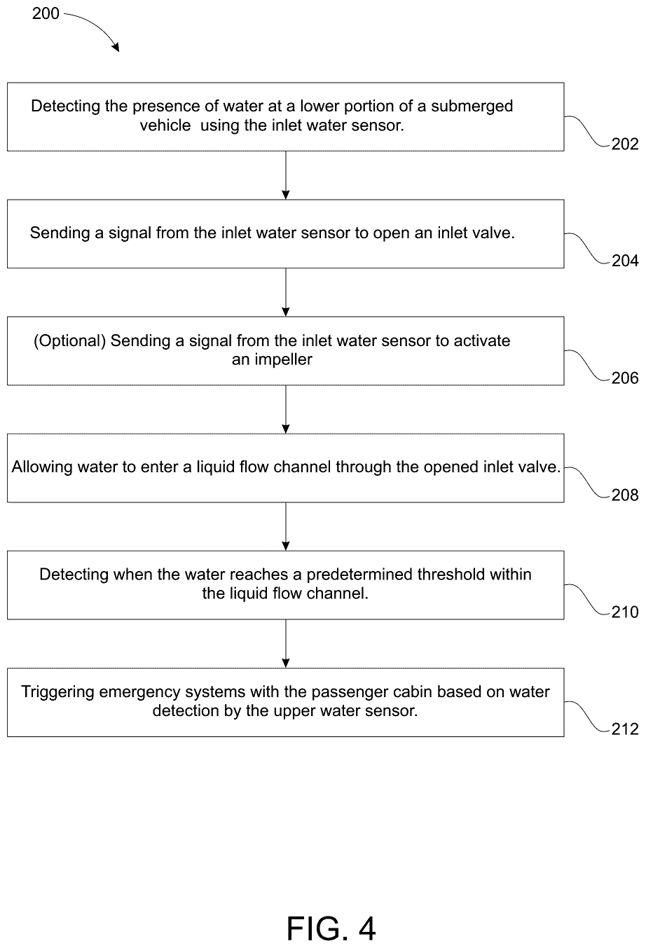

With reference to FIG. 4, a method for activating emergency systems within a submerged vehicle will be described. The first step 202 includes detecting the presence of water at a lower portion of a submerged vehicle using the inlet water sensor 116. The next step 204 includes sending a signal from the inlet water sensor 116 to open an inlet valve 112. For example, the inlet water sensor 116 sends a signal to the control system 126 and the control system 126 causes the inlet valve 112 to open. Optionally, the next step 206 may include sending a signal from the inlet water sensor 116 to activate an impeller 124. The impeller 124 may draw water into the liquid flow channel 114. The next step 208 includes allowing water to enter the liquid flow channel 114 through the opened inlet valve 112. Next, step 210 includes detecting when the water reaches a predetermined threshold within the liquid flow channel 114. The upper water sensor 118 is used to detect when the water reaches the predetermined threshold. Finally, step 212 includes triggering emergency systems (such as emergency lighting or automatic seatbelt release mechanisms) within the passenger cabin based on the water detection by the upper water sensor 118. That is, the upper water sensor 118 sends a signal to the control system 126, which causes activation of the wiring 122 to the emergency systems.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A vehicle safety device comprising:
a housing that is water tight so that components inside the housing are protected from water ingress, wherein the housing comprises a top surface, a bottom surface comprising a bottom sensor opening, and side surfaces extending between the top surface and the bottom surface;
an inlet water sensor operably coupled to the bottom sensor opening in the bottom surface of the housing, wherein the inlet water sensor is configured to detect whether liquid is present near the bottom surface of the housing;
an inlet valve operably coupled to the inlet water sensor, wherein the inlet valve is configured to open when the inlet water sensor detects that liquid is present;
a liquid flow channel extending through the housing and having an inlet end coupled to the inlet valve, and an outlet end at the top surface of the housing; and
an upper water sensor operably coupled to an upper sensor opening adjacent to the outlet end of the liquid flow channel, wherein the upper water sensor is further configured to be operably coupled to emergency systems inside a passenger cabin of the vehicle and to activate the emergency systems when liquid is detected near the top surface of the housing.

2. The device of claim 1, further comprising an impeller operably coupled to the inlet water sensor, wherein the impeller is configured to activate when the inlet water sensor detects that liquid is present to thereby draw liquid into the liquid flow channel.

3. The device of claim 1, further comprising a power source.

4. The device of claim 3, wherein the power source is at least one of a solar panel, a rechargeable battery, a fixed battery, or a vehicle battery.

5. The device of claim 3, wherein the inlet water sensor and the upper water sensor are operably coupled to the power source.

6. The device of claim 1, wherein the housing is configured for being coupled to a vehicle.

7. The device of claim 6, wherein the housing is configured for being coupled to an engine compartment of the vehicle.

8. The device of claim 3, wherein the power source is housed inside the housing.

9. The device of claim 1, wherein the inlet water sensor and the upper water sensor are housed inside the housing.

10. The device of claim 1, further comprising a control system housed inside the housing, wherein the control system is operably coupled to the inlet water sensor, upper water sensor, and the inlet valve.

11. The device of claim 10, wherein the control system comprises a microcontroller programmed to process inputs from the inlet water sensor and the upper water sensor, and to control outputs to the inlet valve and emergency systems within the passenger cabin.

12. The device of claim 1, wherein the inlet valve is additionally configured to minimize resistance to incoming water, featuring a valve gate design that promotes quick and unobstructed water flow.

13. The device of claim 1, wherein the inlet valve comprises a solenoid actuator that is activated by a signal from the inlet water sensor, causing a movable valve gate to open quickly to allow rapid water entry into the liquid flow channel.

14. A method of activating emergency systems in a submerged vehicle, comprising:
detecting the presence of water at a lower portion of the submerged vehicle using an inlet water sensor;
sending a signal from the inlet water sensor to open an inlet valve;
allowing water to enter a liquid flow channel through the opened inlet valve;
detecting when the water reaches a predetermined threshold within the liquid flow channel using an upper water sensor; and
triggering emergency systems within the passenger cabin based on water detection by the upper water sensor.

15. The method of claim 14, further comprising, after detecting the presence of water, sending a signal from the inlet water sensor to activate an impeller that is configured to draw water into the liquid flow channel.
